(19) United States
(12) Patent Application Publication
(10) Pub. No.: US 2014/0306529 A1
(43) Pub. Date: Oct. 16, 2014

(54) DYNAMIC CHARGING OF A RECHARGEABLE BATTERY

(71) Applicant: SEAGATE TECHNOLOGY LLC, Cupertino, CA (US)

(72) Inventors: Philip Yin, Fremont, CA (US); Felix Markhovsky, Saratoga, CA (US); Ashutosh Razdan, San Jose, CA (US)

(73) Assignee: Seagate Technology LLC, Cupertino, CA (US)

(21) Appl. No.: 13/862,130

(22) Filed: Apr. 12, 2013

(51) Int. Cl. H02J 7/00

(52) U.S. Cl. CPC H02J 7/007
USPC 307/31; 320/160

(57) ABSTRACT

An apparatus for charging of a rechargeable battery. The apparatus includes a rechargeable battery, a controller and a circuitry. The circuitry is operable to receive power from a power source. The circuitry is configured to provide power to the rechargeable battery and to other components. The controller is configured to control the circuitry to increase power to the rechargeable battery in response to a decrease in power consumption associated with the other components.

### BACKGROUND

Electronic devices may be charged by connecting them to a power source. For example, an electronic device may be charged by connecting it to a computer or to a wall plug. In general, power source devices, e.g., a computer, a laptop, etc., have a specified maximum output current limit. In some cases, the power source connection also serves another function, such as data transmission. Limiting the amount of current drawn for charging the battery adversely impacts the speed of which the battery is charged.

### SUMMARY

According to one embodiment, the instantaneous power consumption of the electronic device is monitored. The amount of current corresponding to the difference between the maximum operating load of the electronic device and the instantaneous power consumption of the electronic device may be used to charge the battery. As such, the battery may be charged faster while damage to the power source may be prevented.

An apparatus includes a rechargeable battery, a circuitry, and a controller. The circuitry is operable to receive power from a power source. The circuitry is configured to provide power to the rechargeable battery and to other electrical components. The controller is configured to control the circuitry to increase power to the rechargeable battery in response to a decrease in power consumption associated with the other electrical components.

The apparatus may include the above and the power from the power source is selectable using the controller to maintain electrical connection in the power source through a fuse of the power source. The apparatus may also include a monitoring circuit that is configured to monitor power consumption associated with the other electrical components of the apparatus.

These and various other features and advantages will be apparent from a reading of the following detailed description.

### BRIEF DESCRIPTION OF DRAWINGS

Embodiments are illustrated by way of example, and not by way of limitation, in the figures of the accompanying drawings and in which like reference numerals refer to similar elements.

FIG. 1A shows a device configured to charge its battery in accordance with one embodiment.

FIG. 1B shows an exemplary device capable of charging its battery in accordance with one embodiment.

FIG. 2 shows a fast charging device in accordance with various embodiments.

FIG. 3 shows a fast charging device in accordance with one exemplary embodiment.

FIG. 4 shows an exemplary flow diagram for fast charging a device in accordance with one embodiment.

FIG. 5 shows an exemplary flow diagram for selecting a power level for charging a battery in accordance with one embodiment.

FIG. 6 shows an exemplary flow diagram for dynamically selecting a battery charge in accordance with one embodiment.

FIG. 7 shows an exemplary flow diagram for charging the battery in accordance with one embodiment.

### DETAILED DESCRIPTION

According to embodiments described herein, the speed at which a battery of an electronic device is charged is increased while other functions are not utilizing the available power. Furthermore, the speed at which a battery of an electronic device is charged is increased while preventing the power source from interrupting supplying power to the electronic device, according to one embodiment.

Some power source devices may be equipped with a fuse that temporarily interrupts power when the maximum output current limit is exceeded. However, continuously interrupting the power is disruptive to charging of the electronic device. In order to maintain power, the amount of current drawn to charge the battery may be limited to the difference between the smallest maximum output current limit of all interconnection interfaces and the current associated with the maximum load of the electronic device. For example, the amount of current drawn to charge a battery of the electronic device from a USB interface may be limited to the difference between the current associated with the maximum load of the electronic device and the maximum output current limit.

According to one embodiment, the instantaneous power consumption of the electronic device is monitored. As a result, the amount of current associated with the power consumption can be determined. It is appreciated that monitoring the instantaneous power consumption may be accomplished by measuring the amount of current used by the electronic device.

The maximum current output limit associated with the power source is received or determined. The instantaneous power consumption of the electronic device may be used with a maximum current output limit, as specified by the power source, to dynamically adjust the amount of current used to charge the battery. According to one embodiment, the amount of current used to charge the battery may be dynamically adjusted to the difference between the maximum current output limit and the current associated with the instantaneous power consumption.

In other words, the amount of current used to charge the battery may be increased during low power consumption of the electronic device while the amount of current used to charge the battery may be decreased during higher power consumption of the electronic device. As such, the speed at which the battery is charged is increased while protecting the power source from being damaged. Moreover, interruption to supply power from the power source to the electronic device is prevented, e.g., by preventing the fuse to short the circuit.

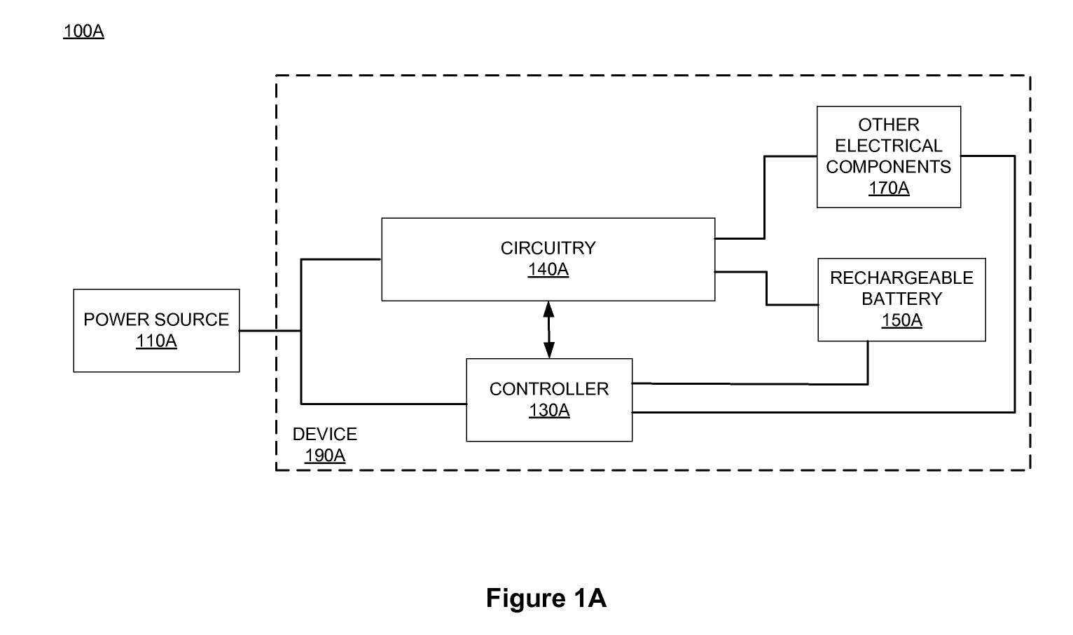

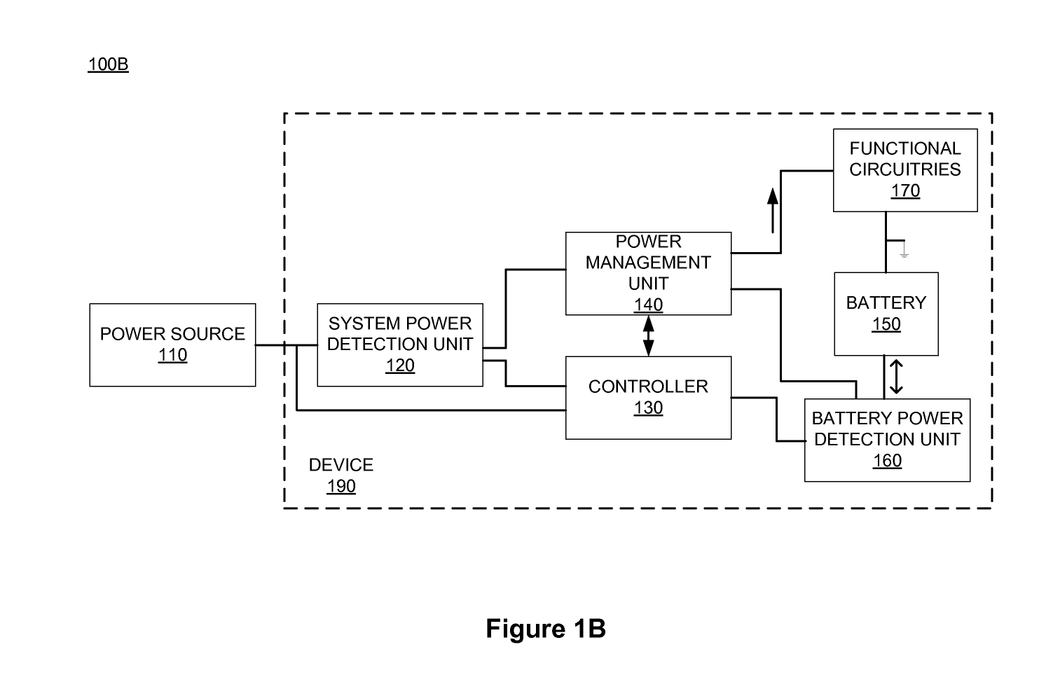

Referring now to FIG. 1A, a device configured to charge its battery in accordance with one embodiment is shown. The power source 110A is coupled to the device 190A. The device 190A can be charged using the power source 110A. The device 190A may be a portable electronic device such as a cellular phone, a mobile phone, a smart phone, a digital camera, a portable storage device, a storage device such as a hard drive or a solid state device, a Wi-Fi enabled storage device, a tablet, a laptop, a portable media player, etc. Device 190A includes a circuitry 140A, a controller 130A, a rechargeable battery 150A, and other electrical components 170A.

The circuitry 140A may receive power from the power source 110A. Furthermore, the circuitry 140A may provide power to the rechargeable battery 150A and to other electrical components 170A of the device. The controller 130A is configured to monitor the instantaneous power consumption associated with the device 190A. It is appreciated that the monitored power consumption may be associated with the power consumption of the controller 130A, power consumption of other electrical components 170A or any combination thereof. In one instance, the power consumption may be associated with any functionality and circuitry of the device 190A other than the rechargeable battery 150A.

According to one embodiment, in response to monitoring the power consumption of the device, the controller 130A adjusts the amount of power provided to the rechargeable battery 150A. For example, the controller 130A may cause the amount of current provided from the circuitry 140A to the rechargeable battery 150A to increase in response to a decrease in the amount of power consumption of the device. In contrast, the controller 130A may cause the amount of current provided from the circuitry 140A to the rechargeable battery 150A to decrease in response to an increase in the amount of power consumption of the device.

Referring now to FIG. 1 B, an exemplary electronic device 190 capable of fast charging its battery while protecting the power source 110 in accordance with one embodiment is shown. System 100B includes the power source 110 and the electronic device 190 that is being charged. The electronic device 190 may be a portable electronic device such as a cellular phone, a mobile phone, a smart phone, a digital camera, a portable storage device, a storage device such as a hard drive or a solid state device, a Wi-Fi enabled storage device, a tablet, a laptop, a portable media player, etc.

Device 190 includes a system power detection unit 120, a controller 130, power management unit 140, a battery 150, a battery power detection unit 160, and functional circuitries 170. The system power detection unit 120 is configured to monitor the instantaneous power consumption associated with the device 190. In one embodiment, the battery 150 may be a rechargeable Lithium Ion battery. In another embodiment, the battery 150 may be a rechargeable Nickel Cadmium battery or any other type of rechargeable battery.

It is appreciated that the monitored power consumption may be associated with the power consumption of the controller 130 and the functional circuitries 170, in one embodiment. It is appreciated that, in one instance, the power consumption may be associated with any functionality and circuitry of the device 190 other than the battery 150. In one exemplary embodiment, the power consumption may be associated with the amount of power consumption of the functional circuitries 170. It is appreciated that the functional circuitries 170 refer to circuitries of the device other than the circuitries associated with the battery functionality. For example, the functional circuitries 170 may include a storage functionality, data transmission functionality, Wi-Fi functionality, processing functionality, controller functionality, media playing or streaming, etc.

According to one embodiment, the system power detection unit 120 may monitor and detect the amount of current drawn in order to determine the amount of power consumption. For example, the system power detection unit 120 may monitor and detect the amount of current drawn by the functional circuitries 170.

The system power detection unit 120 may be coupled to the controller 130 and the power management unit 140. The controller 130 may control the operation of the power management unit as well as controlling other operations of the electronic device 190 (not shown). It is appreciated that the power management unit 140 may include a charge circuitry for supplying power to the battery 150 and to the functional circuitries 170. It is further appreciated that the power management unit 140 may also include a power path manager for supplying an appropriate amount of power to each of the battery 150 and the functional circuitries 170. It is noted that references to a power management unit throughout this disclosure may refer to the charge circuitry, a power path management unit, or any combination thereof.

The system power detection unit 120 may provide the electrical power received from the power source 110 to the power management unit 140. The system power detection unit 120 may also provide the detected power consumption to the controller 130.

The controller 130 may also receive the maximum current output limit associated with the power source 110. It is appreciated that the power source 110 manufacturer may specify the maximum current output limit. The maximum current output limit is the amount of current that can be safely drawn from the power source 110.

It is appreciated that in some embodiments the maximum current output limit may be determined by another component (not shown) and communicated to the controller 130. Alternatively, for example, the maximum current output limit may be communicated via the power source 110 to the controller 130. In various embodiments, a number of maximum current output limits associated with various interconnection interfaces may be stored in a memory component (not shown) accessible by the controller 130. As such, after detecting the type of interconnection interface, e.g., USB 2.0, USB 3.0, SATA, Thunderbolt, Firewire, etc., the controller 130 may fetch the appropriate maximum current output limit stored in a memory component.

The controller 130 may use the maximum current output limit, associated with a particular interconnection interface used to couple the device 190 to the power source 110, and the current associated with the power consumption of the device 190 to determine the amount of current that can be diverted and used to charge the battery 150 while preventing the power source 110 from being damaged or preventing the power source 110 from interrupting the supply of power to the electronic device, e.g., by blowing its fuse. According to one embodiment, the amount of current used to charge the battery 150 may be set to the difference between the maximum current output limit associated with a particular interconnection interface and the current associated with the power consumption of the device 190.

The controller 130 may communicate the amount of current to be used to charge the battery 150 to the power management unit 140. The power management unit 140 provides enough power, hence current, to the functional circuitries 170 based on its instantaneous power consumption. The power management unit 140 also provides the determined amount of current to charge the battery 150, as determined by the controller 130, via the battery power detection unit 160. The power management unit 140 may be a combination of field effect transistors (FET), capacitors, inductors, and/or resistors in accordance with various embodiments.

In one embodiment, the battery power detection unit 160 monitors the amount of current and/or voltage of the battery. The battery power detection unit 160 may also monitor and determine the direction of current flow into/from the battery 150. In other words, the battery power detection unit 160 may determine whether the battery is being charged or discharged. The amount of current or voltage and whether the battery 150 is being charged or discharged may be communicated from the battery power detection unit 160 to the controller 130.

In one embodiment, in response to receiving information from the battery power detection unit 160, the controller 130 may control the power management unit 140 to, for example, provide a constant current to the battery 150 if the battery charge is below a certain threshold, e.g., below 90%, 80%, 75%, 50% charge. It is appreciated that in another instance, in response to receiving information regarding the amount of current or voltage and whether the battery 150 is being charged or discharged, the controller 130 may control the power management unit 140 to provide a constant voltage to the battery 150 if the battery charge is above a certain threshold, e.g., above 90%, 80%, 75%, 50% charge.

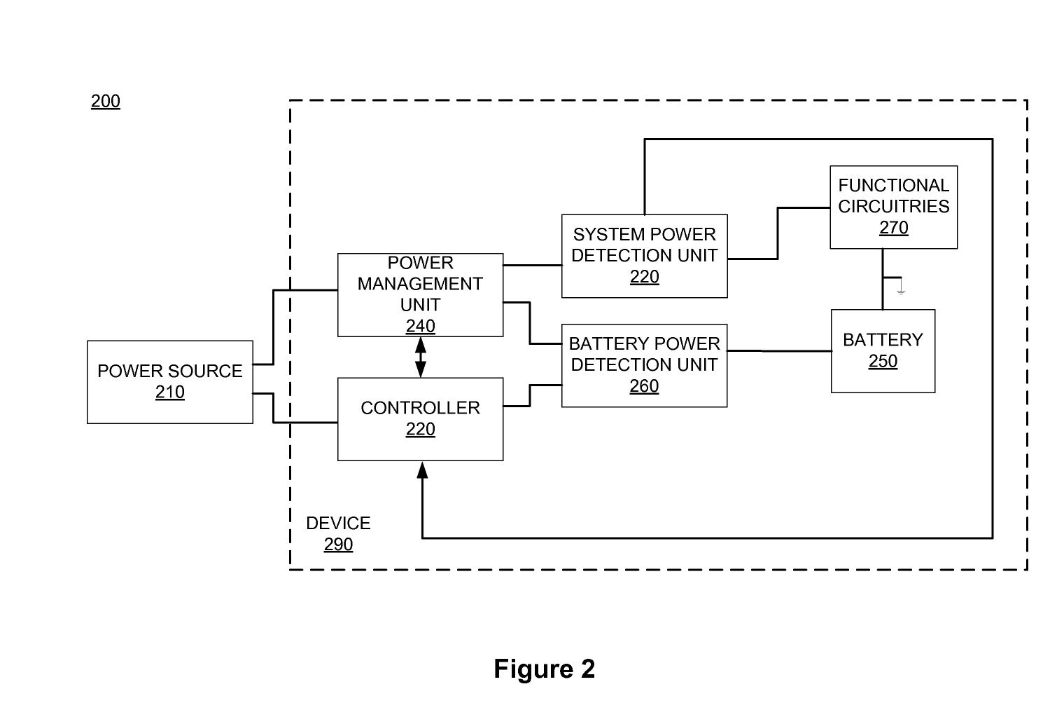

Referring now to FIG. 2, a fast charging device while protecting the power source in accordance with one embodiment is shown. It is appreciated that system 200 functions substantially similar to that of FIG. 1 except that the topology for monitoring power consumption of the device is different. In this embodiment, the system power detection unit 220 is coupled between the power management unit 240 and the functional circuitries 270. However, the system power detection unit 220 functions substantially similar to that of system power detection unit 120.

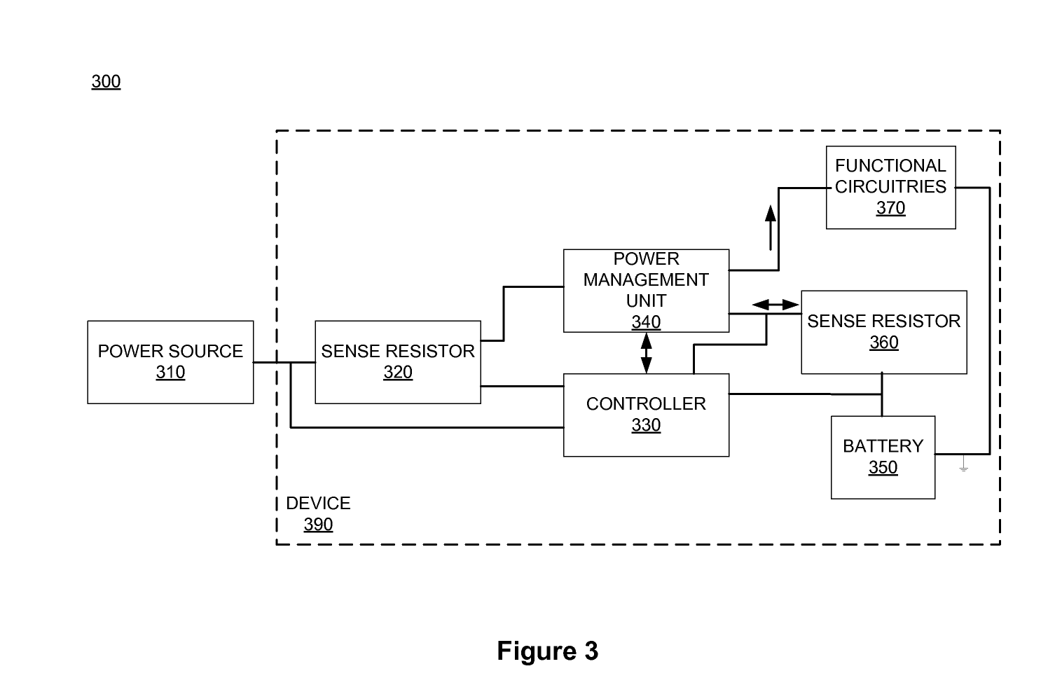

Referring now to FIG. 3, a fast charging device while protecting the power source in accordance with one exemplary embodiment is shown. System 300 is substantially similar to that of FIG. 1 where the power detection units 120 and 160 are sense resistors 320 and 360 respectively. Sense resistors are used to measure and monitor the amount of current passing through. For example, the sense resistor 320 may be used to monitor the amount of current being consumed by the functional circuitries 370 of the device 390. Similarly, the sense resistor 360 may be utilized to monitor the amount of current to/from the battery 350. In other words, the sense resistors may be used to monitor the amount of power being consumed by circuitries of the device 390 and/or the battery 350. It is appreciated that power may be monitored via other means. For example, power monitoring may be accomplished using inductive elements. If an inductive element is used, the magnetic field may be measured and the amount of current going through the inductive element may be derived.

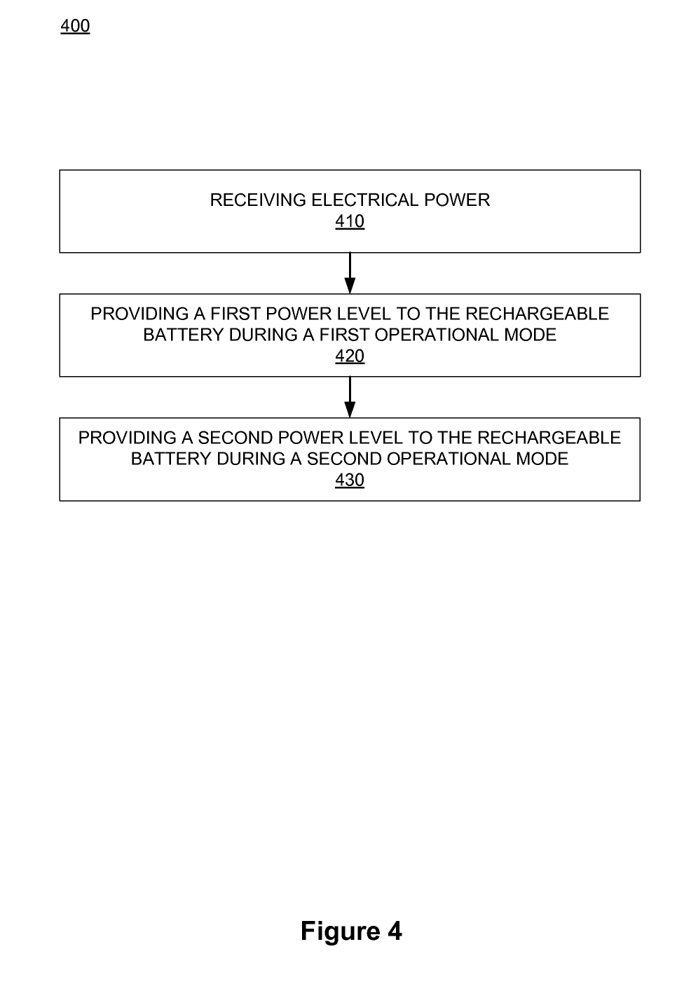

Referring now to FIG. 4, an exemplary flow diagram 400 for fast charging a device in accordance with one embodiment is shown. At step 410, electrical power is received. For example, the power source may provide electrical power to the electronic device. It is appreciated that the electronic device may select the amount of electrical power and based on the maximum current output limit as specified by the power source. It is further appreciated that the maximum current output limit may be based on the type of interconnection interface, e.g., USB 2.0, USB 3.0, SATA, Thunderbolt, Firewire, etc., that is used to charge the electronic device.

At step 420, a first power level is provided to the rechargeable battery of the device during a first operational mode, e.g., processing data, sleep mode, running an application, storing data, fetching data, etc. A certain amount of electrical power is needed by the electronic device in order to function and remain in its first operational mode. As a result, the amount of electrical power remaining, hence the difference between the maximum current output limit and the current used to power the first operational mode, may be used to charge the rechargeable battery. Accordingly, the battery is being charged at maximum speed while preventing the power source from being damaged or preventing the power source from interrupting the supply of power to the electronic device, e.g., by blowing a fuse.

At step 430, a second power level is provided to the rechargeable battery of the device during a second operational mode, e.g., data transmission, Wi-Fi mode, etc. A certain amount of electrical power is needed by the electronic device in order to function and remain in its second operational mode. As a result, the amount of electrical power remaining, hence the difference between the maximum current output limit and the current used to power the second operational mode, may be used to charge the rechargeable battery. In one embodiment, if the second operational mode utilizes more power in comparison to the first operational mode, a smaller amount of current is being used to charge the battery. In contrast, if the second operational mode utilizes less power in comparison to the first operational mode, a larger amount of current is used to charge the battery. Accordingly, the battery is charged at maximum allowed speed without damaging the power source or without causing the power supply to interrupt the supply of power to the electronic device, e.g., by blowing its fuse. In one exemplary embodiment, the second power level is greater than the first power level and in some embodiments it can be at least 1.1, 1.2, 1.5, 2 or 3 times the first power level.

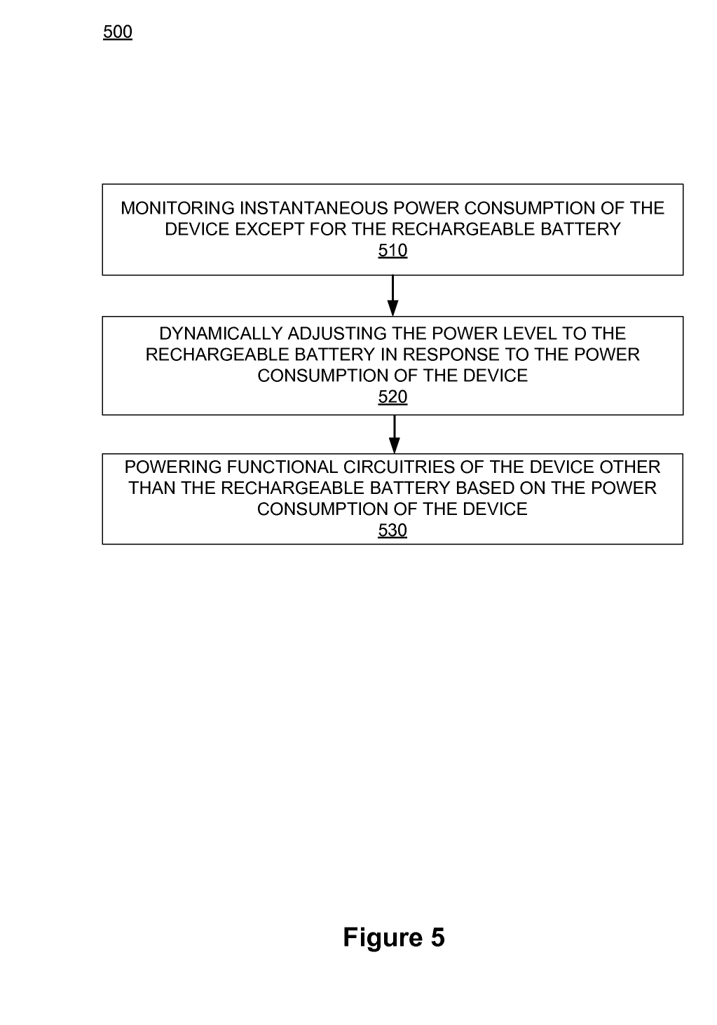

Referring now to FIG. 5, an exemplary flow diagram 500 for selecting a power level for charging a battery in accordance with one embodiment is shown. At step 510, the instantaneous power consumption of the device may be monitored and measured. It is appreciated that the instantaneous power consumption of the device may be power consumption of the device except for charging the battery.

At step 520, the power level to charge the rechargeable battery may be adjusted based on the power consumption of the device. For example, if the power consumption of the device is decreased the power level for charging the battery may be increased by the same amount. In contrast, if the power consumption of the device is increased, the power level for charging the battery may be decreased by the same amount. According to one embodiment, the power level is adjusted by adjusting the amount of current supplied to the battery. It is appreciated that the amount of power supplied to the electronic device may be selected based on the maximum current output limit, as described above.

At step 530, functional circuitries of the device other than the rechargeable battery may be powered in order to keep them operational. For example, as much power as needed may be supplied to the functional circuitries in order to enable the device to complete its task other than charging the battery.

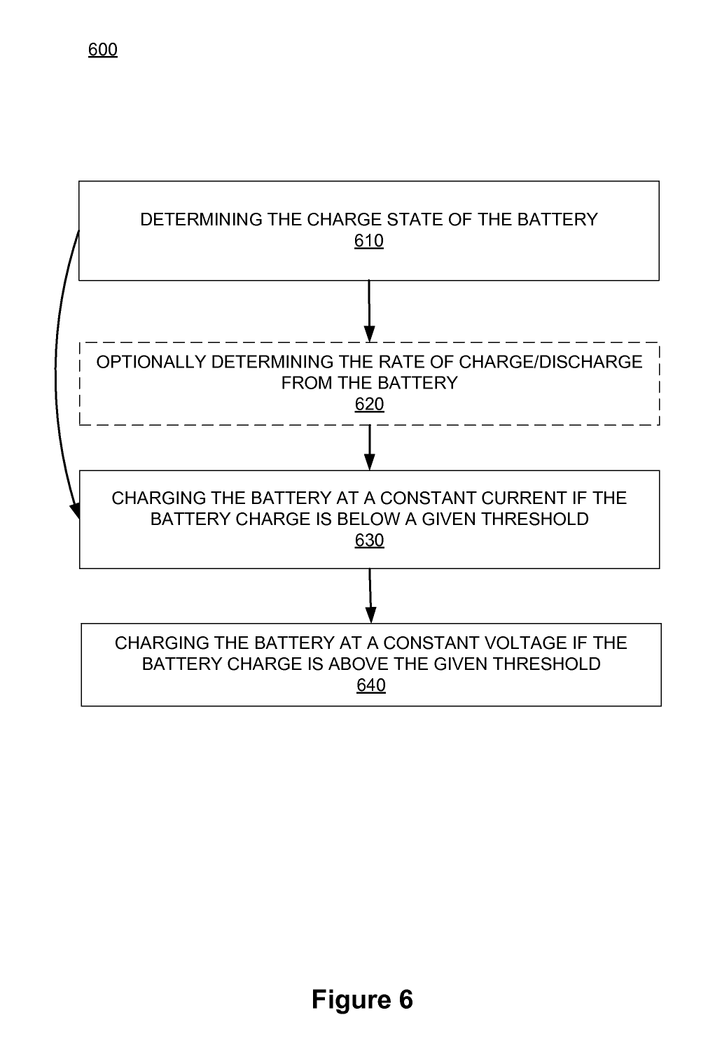

Referring now to FIG. 6, an exemplary flow diagram for dynamically selecting a battery charge in accordance with one embodiment is shown. At step 610, a charge state of the battery may be determined. For example, determining the charge state may indicate that the battery is 85% full. At step 620, the rate at which the battery is being charged/discharged may optionally be determined. At step 630, the battery may be charged at a constant current if the battery charge state is below a certain threshold, e.g., below 80%. However, at step 640, the battery may be charged at a constant voltage if the battery charge state is above a certain threshold, e.g., above 80%.

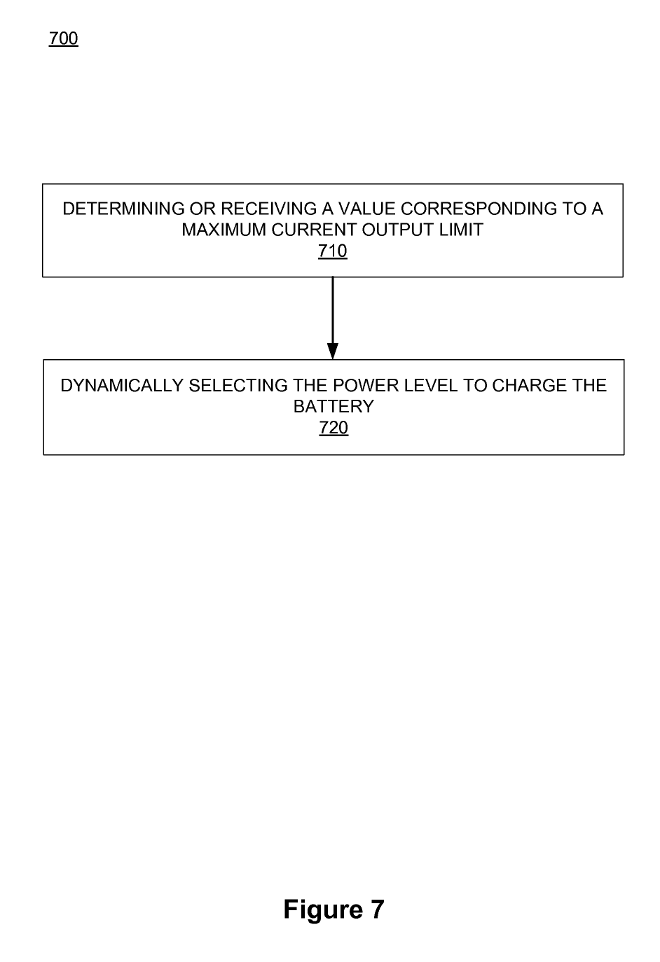

Referring now to FIG. 7, an exemplary flow diagram for charging the battery in accordance with one embodiment is shown. At step 710, a value corresponding to a maximum amount of current that can be safely be provided by the power source to the electronic device may be determined or received. For example, the maximum current output limit may be determined by transmitting that information from the power source to the electronic device or alternatively various maximum current output limits may be stored in a table in the electronic device. Accordingly, when the interconnection interface connects the electronic device to the power source, the type of interface is determined and the maximum current output limit may be determined using the table.

At step 720, the power level for charging the battery may be dynamically selected. It is appreciated that the power level for charging the battery may be selected based on the power consumption of the device except for charging the battery and further based on the maximum current output limit as specified by the power source. For example, the power level for charging the battery may be the difference between the current associated with the power consumption of the device and the maximum current output limit. As such, the battery is charged at maximum allowed speed without damaging the power source or without causing the power supply to interrupt the supply of power to the electronic device, e.g., by blowing its fuse.

An exemplary computer system for charging a battery in accordance with some embodiments includes a bus or other communication mechanism for communicating information, and a processor coupled with bus for processing information. A computer system may implement the method for charging a battery as shown in FIGS. 4-7. The bus is capable of providing power to a device in addition to enabling other functions.

The term “computer-readable medium” as used herein refers to any medium that participates in providing instructions to a processor for execution. Such a medium may take many forms, including but not limited to, non-volatile media, volatile media, and transmission media. Non-volatile media includes, for example, optical or magnetic disks. Volatile media includes dynamic memory, such as main memory. Transmission media includes coaxial cables, copper wire and fiber optics. Transmission media can also take the form of acoustic or light waves, such as those generated during radio wave and infrared data communications.

Common forms of computer-readable media include, for example, a flexible disk, hard disk, hard drive, magnetic tape, or any other magnetic medium, a CD-ROM, any other optical medium a RAM, a PROM, and EPROM, a FLASH-EPROM, any other memory chip or cartridge, a carrier wave as described hereinafter, or any other medium from which a computer can read.

In some embodiments, the present invention is used with a portable hard drive capable of fast charging a battery when resources are not needed to accomplish a data transfer. A disk drive may be included as part of the functional circuitries described above. The functional circuitries may also include a wireless circuitry.

An interface or drive connector along an exterior of the disk drive may be used to provide connectivity between circuitry of the disk drive and a next level of integration such as an interposer, a circuit board, a cable connector, a host, or an electronic assembly.

References were made in detail to embodiments, examples of which were illustrated in the accompanying drawings. While the embodiments were described in conjunction with the drawings, it is understood that they were not intended to limit the embodiments. On the contrary, the embodiments are intended to cover alternatives, modifications and equivalents. Furthermore, in the detailed description, numerous specific details were set forth in order to provide a thorough understanding. However, it is recognized by one of ordinary skill in the art that the embodiments may be practiced without these specific details. In other instances, well-known methods, procedures, components, and circuits have not been described in detail as not to unnecessarily obscure aspects of the embodiments.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The implementations described above and other implementations are within the scope of the following claims.

What is claimed is:

1. An apparatus comprising:
a rechargeable battery;
a circuitry operable to receive power from a power source, the circuitry configured to provide power to the rechargeable battery and to other electrical components; and
a controller configured to control the circuitry to increase power to the rechargeable battery in response to a decrease in power consumption associated with the other electrical components.

2. The apparatus of claim 1, wherein power from the power source is selectable using the controller to maintain electrical connection in the power source through a fuse of the power source.

3. The apparatus of claim 1 further comprising:
a monitoring circuit configured to monitor power consumption associated with the other electrical components.

4. The apparatus of claim 1 further comprising:
a monitoring circuit configured to determine charge state associated with the rechargeable battery, wherein the controller is further configured to cause the circuitry to provide a substantially constant current to the rechargeable battery if charge level associated with the rechargeable battery is below a threshold, and wherein the controller is further configured to cause the circuitry to provide a substantially constant voltage to the rechargeable battery if the charge level associated the rechargeable battery is above the threshold.

5. The apparatus of claim 1, wherein the apparatus is a portable storage device.

6. The apparatus of claim 5, wherein the portable storage device comprises a hard drive or a solid state drive.

7. The apparatus of claim 1, wherein the apparatus is a portable electronic device selected from a group consisting of mobile phone, smart phone, digital camera, portable media player, and tablet computer.

8. The apparatus of claim 1, wherein the other electrical components perform a with data transmission operation.

9. The apparatus of claim 1, wherein the circuitry comprises an interface selected from a group consisting of universal serial bus (USB), Thunderbolt, Firewire, and serial ATA (SATA).

10. A method comprising:
receiving power from a power source for a device;
providing a first power level to a rechargeable battery of the device during a first operational mode of the device; and
providing a second power level, higher than the first power level, to the rechargeable battery during a second operational mode.

11. The method of claim 10 further comprising:
monitoring power consumption associated with the device; and
selecting a power level for charging the rechargeable battery to maintain electrical connection in a fuse of the power source.

12. The method of claim 11, wherein the power level for charging the rechargeable battery circuit is the difference between the power from the power source and the power consumption associated with the device.

13. The method of claim 10, wherein the first operational mode comprises transmitting data to or from the device.

14. The method of claim 10, wherein power is received via an interface compliant with universal serial bus (USB), Thunderbolt, Firewire, or serial ATA (SATA).

15. The method of claim 10 further comprising:
dynamically adjusting the first power level and the second power level in response to a change in power consumption of the device.

16. The method of claim 10 further comprising:
determining a charge state associated with the rechargeable battery;
providing a substantially constant current to the rechargeable battery if a charge level associated with the rechargeable battery is below a threshold; and
providing a substantially constant voltage to the rechargeable battery if the charge level associated with the rechargeable battery is above the threshold.

17. The method of claim 10, wherein the device is a portable storage device or a smart phone.

18. The method of claim 10, wherein the second power level is at least 1.1 times the first power level.

19. A device comprising:
a rechargeable battery;
an interface operable to receive power from a power source and to provide power to the rechargeable battery and to other electrical components of the device; and
a controller configured to dynamically control an amount of power received from the power source, the controller is further configured to cause the interface to charge the rechargeable battery at a faster rate when the other electrical components operate at less than a maximum power load in comparison to when the other electrical components operate at the maximum power load.

20. The apparatus of claim 19, wherein the controller is configured to cause the interface to provide a higher power to the rechargeable battery in response to a drop in power consumption associated with completion of a data transmission operation.

21. The apparatus of claim 19 further comprising:
a monitoring circuit configured to monitor power consumption associated with the other electrical components of the device.

22. A controller including a computer readable medium storing instructions therein that when executed implement a method comprising:
receiving electrical power from a power source for a device;
providing a first power level from the power source to a rechargeable battery circuit of the device during a first operational mode of the device; and
providing a second power level, higher than the first power level, from the power source to the rechargeable battery circuit during a second operational mode of the device.

23. The controller of claim 22, wherein the method further comprises:
monitoring power consumption associated with the device; and
selecting the power level for charging the rechargeable battery circuit, wherein the power is selected to maintain electrical connection in a fuse of the power source.
